(19) United States
(12) Patent Application Publication
(10) Pub. No.: US 2024/0008556 A1
(43) Pub. Date: Jan. 11, 2024

(54) ELECTRONIC VAPORIZATION DEVICE, POWER SUPPLY ASSEMBLY, AND HOLDER ASSEMBLY

(71) Applicant: SHENZHEN SMOORE TECHNOLOGY LIMITED, Shenzhen (CN)

(72) Inventors: Wenxiao XU, Shenzhen (CN); Xinyu WANG, Shenzhen (CN)

(21) Appl. No.: 18/471,904

(22) Filed: Sep. 21, 2023

Related U.S. Application Data
(63) Continuation of application No. PCT/CN2021/082792, filed on Mar. 24, 2021.

(51) Int. Cl. A24F 40/70; A24F 40/42; A24F 40/10; A24F 40/90

(52) U.S. Cl. CPC A24F 40/70; A24F 40/42; A24F 40/10; A24F 40/90

(57) ABSTRACT

A holder assembly includes: a holder for accommodating a battery cell; and a conductive structure arranged on the holder. The conductive structure is formed on the holder using a laser direct structuring (LDS) process and forms an integral structure with the holder. In an embodiment, the holder has a bottom wall, and the conductive structure is at least partially formed on an inner surface of the bottom wall.

### CROSS-REFERENCE TO PRIOR APPLICATION

This application is a continuation of International Patent Application No. PCT/CN2021/082792, filed on Mar. 24, 2021. The entire disclosure is hereby incorporated by reference herein.

### FIELD

The present invention relates to vaporization devices, and more specifically, to an electronic vaporization device, a power supply assembly, and a holder assembly.

### BACKGROUND

In the related art, assembly operations of a battery cell in an electronic vaporization device are complex, for example, a wire needs to be welded manually. Therefore, a safe and reliable battery cell structure with a simple structure and quick assembly operations is needed to implement automatic production of battery cells.

### SUMMARY

In an embodiment, the present invention provides a holder assembly, comprising: a holder configured to accommodate a battery cell; and a conductive structure arranged on the holder, wherein the conductive structure is formed on the holder using a laser direct structuring (LDS) process and forms an integral structure with the holder.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic vaporization device according to a first embodiment of the present invention.

FIG. 2 is a schematic structural diagram of a power supply assembly of the electronic vaporization device shown in FIG. 1.

FIG. 3 is a schematic partial structural diagram of the power supply assembly shown in FIG. 2.

FIG. 4 is a schematic partial structural exploded view of the power supply assembly shown in FIG. 3.

FIG. 5 is a schematic structural diagram of a holder assembly of the power supply assembly shown in FIG. 4.

FIG. 6 is a schematic structural diagram of a holder of the holder assembly shown in FIG. 5.

FIG. 7 is a schematic structural diagram of a conductive structure of the holder assembly shown in FIG. 5.

FIG. 8 is a schematic structural diagram of a first circuit board of the power supply assembly shown in FIG. 4.

FIG. 9 is a schematic structural diagram of a second circuit board of the power supply assembly shown in FIG. 4.

FIG. 10 is a schematic structural diagram of a holder assembly of an electronic vaporization device according to a second embodiment of the present invention.

### DETAILED DESCRIPTION

In an embodiment, the present invention provides an improved electronic vaporization device, a supply assembly, and a holder assembly.

In an embodiment, the present invention provides a holder assembly, including a holder configured to accommodate a battery cell, and a conductive structure arranged on the holder.

The conductive structure is formed on the holder by using a laser direct structuring (LDS) process and forms an integral structure with the holder.

Preferably, the holder includes a bottom wall, and the conductive structure is at least partially formed on the inner surface of the bottom wall.

Preferably, the holder includes a side wall; and

the conductive structure is at least partially formed on the inner surface of the side wall.

Preferably, the battery cell includes a first end extending in the length direction and a second end arranged opposite to the first end; and the conductive structure extends from the first end of the battery cell to the second end.

Preferably, the holder includes a first accommodating cavity accommodating the battery cell; and the conductive structure is formed in the first accommodating cavity.

Preferably, the holder includes a second accommodating cavity accommodating a first circuit board; and

the conductive structure extends from the first accommodating cavity to the second accommodating cavity.

Preferably, the holder includes a third accommodating cavity accommodating a second circuit board; and

the conductive structure extends from the first accommodating cavity to the third accommodating cavity.

Preferably, the conductive structure includes a first electrode extending toward the second accommodating cavity; and

the first electrode is formed in the second accommodating cavity by using the LDS process, to abut against a first elastic electrode arranged on the first circuit board.

Preferably, a first positioning boss is arranged in the second accommodating cavity; and the first electrode is formed on the first positioning boss by using the LDS process.

Preferably, the conductive structure includes a second electrode extending toward the third accommodating cavity; and

the second electrode is formed in the third accommodating cavity by using the LDS process, to abut against a second elastic electrode arranged on the second circuit board.

Preferably, a second positioning boss is arranged in the third accommodating cavity; and

the second electrode is formed on the second positioning boss by using the LDS process.

Preferably, the conductive structure includes at least one conductive member; and

the conductive member includes an elongated conductive connection portion, and the whole conductive connection portion is formed on the holder by using the LDS process.

Preferably, a first electrode is arranged on the end of the conductive connection portion of each conductive member, and a second electrode is arranged on the other end of the conductive connection portion of each conductive member.

Preferably, the conductive connection portion, the first electrode, and the second electrode are integrally formed on the holder by using the LDS process, and form an integral structure with the holder.

Preferably, the conductive structure includes at least two conductive members; and

a first electrode is arranged on each conductive member; and

the first electrodes on two adjacently arranged conductive members are arranged in mirror symmetry.

Preferably, the conductive structure includes at least two conductive members;

a second electrode is arranged on each conductive member; and

the second electrodes on two adjacently arranged conductive members are arranged in mirror symmetry.

The present invention further constructs a power supply assembly, including the holder assembly described in the present invention and a battery cell arranged on the holder assembly.

The present invention further constructs an electronic vaporization device, including the power supply assembly described in the present invention and a vaporizer connected to the power supply assembly.

Beneficial Effects:

By implementing the electronic vaporization device, the power supply assembly, and the holder assembly of the present invention, the following beneficial effects can be achieved. In the holder assembly, the conductive structure is formed on the holder by using the LDS process and forms an integral structure with the holder, thereby facilitating automatic assembly of the battery cell and increasing efficiency of automatic assembly of the battery cell.

In order to have a clearer understanding of the technical features, the objectives, and the effects of the present invention, specific implementations of the present invention are now illustrated in detail with reference to the accompanying drawings.

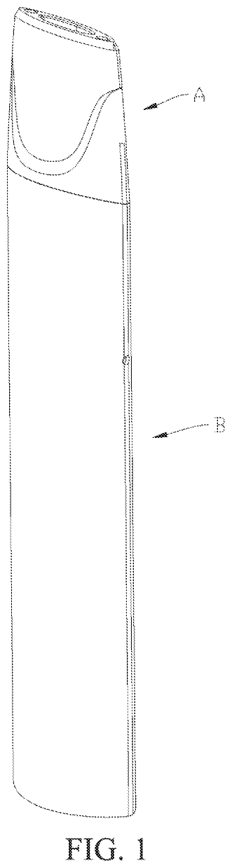

FIG. 1 shows a first embodiment of an electronic vaporization device of the present invention. In this embodiment, the electronic vaporization device includes a vaporizer A and a power supply assembly B. The vaporizer A may be configured to heat a vaporizable medium. The power supply assembly B may be mechanically and/or electrically connected to the vaporizer A and may supply electric energy to the vaporizer A.

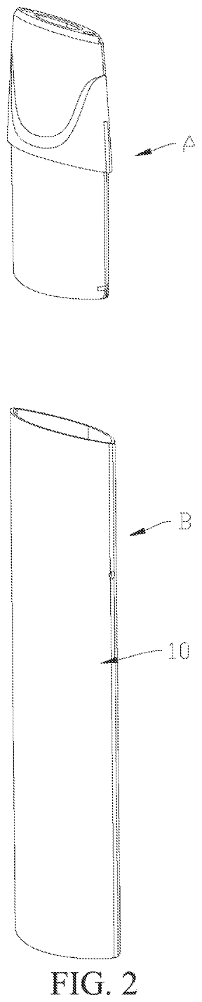

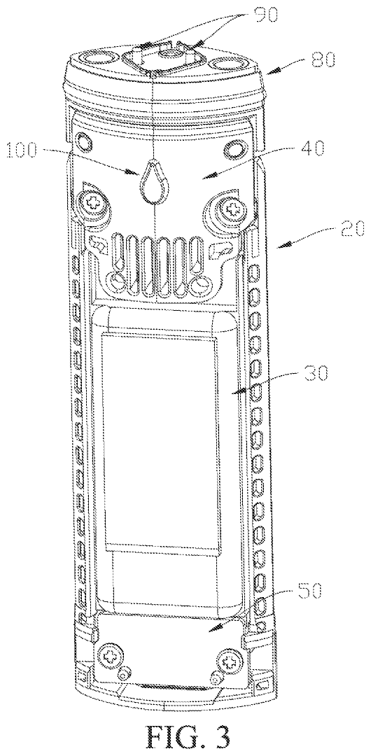

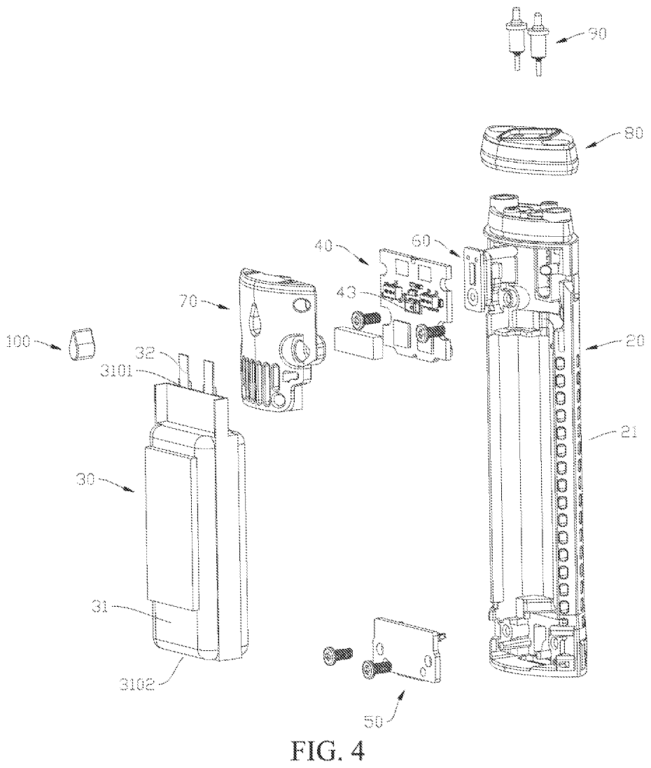

As shown in FIG. 2 to FIG. 4, further, in this embodiment, the power supply assembly includes a shell 10, a holder assembly 20, a battery cell 30, a first circuit board 40, and a second circuit board 50. The shell 10 is configured to accommodate the holder assembly 20, the battery cell 30, and the first circuit board 40. The holder assembly 20 is arranged in the shell 10 and may support the battery cell 30 and the first circuit board 40. The battery cell 30 is arranged on the holder assembly 20 and located at the lower part of the holder assembly 20, and may supply electric energy to the vaporizer A. The first circuit board 40 may be arranged on the holder assembly 20 and may be electrically connected to the battery cell 30. The second circuit board 50 may be arranged on the holder assembly 20 and electrically connected to the first circuit board 40, and may be connected to an external power supply to charge the battery cell 30.

Further, in this embodiment, the shell 10 is in a barrel-shaped structure with an opening. The shell 10 may be a plastic injection member. Certainly, it may be understood that, in some other embodiments, the shell 10 may alternatively be a metal shell.

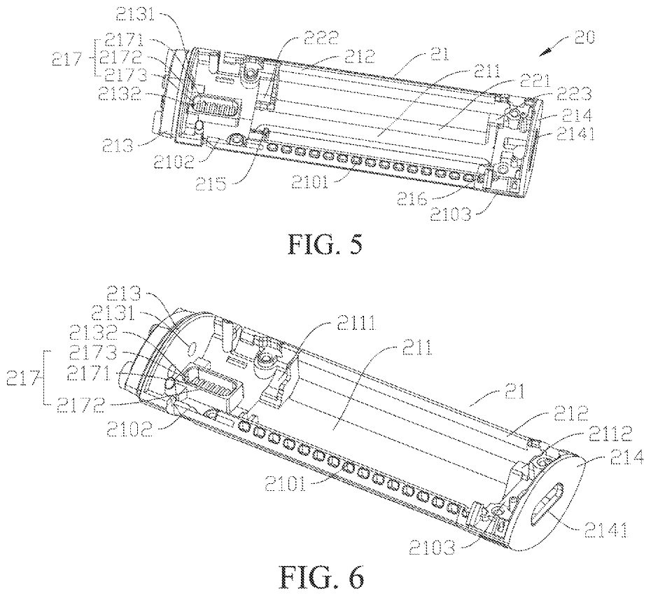

As shown in FIG. 5 and FIG. 6, further, in this embodiment, the holder assembly 20 may include a holder 21 and a conductive structure 22. The holder 21 may be configured to accommodate the battery cell 30 and the first circuit board 40. The conductive structure 22 may be arranged on the holder 21 and may be integrally formed with the holder 21.

Further, in this embodiment, the holder 21 may be substantially in a flat shape, and in some embodiments, the cross-sectional view of the holder 21 may be in an ellipse shape. The holder 21 may be an insulator. Specifically, in some embodiments, the holder 21 may be a plastic injection member, and preferably, the holder 21 may be plastic on which laser activation can be performed. The plastic contains a special additive in an organic metallic composite form. The additive may have physical and chemical reactions and be activated under illumination of a focused laser beam. After being activated, the plastic undergoes organic copper plating immersion to form a conductive circuit. Certainly, it may be understood that, in some other embodiments, the holder 21 may not be limited to being made of a plastic material, and may be made of ceramic or another material. Certainly, it may be understood that, in some embodiments, the holder 21 may not be limited to the insulator, either, and may be arranged to be insulated from the conductive structure 22 by arranging an insulator.

In this embodiment, the holder 21 may include a bottom wall 211, side walls 212, a first end wall 213, and a second end wall 214. The bottom wall 211 may be a long bottom wall. There are two side walls 212, and the two side walls 212 may be arranged on the two opposite sides of the bottom wall 211 and may be spaced apart from the bottom wall 211. The side walls 212 may be integrally formed with the bottom wall 211, and a hollow-out structure 2110 may be arranged between each side wall 212 and the bottom wall 211. The hollow-out structure 2110 can facilitate releasing of the whole holder 21 from a mold. The first end wall 213 may be arranged on the end of the bottom wall 211 and connected to the two side walls 212, and may be connected to the vaporizer. The second end wall 214 may be arranged on the other end of the bottom wall 211 and connected to the two side walls 212, and are arranged opposite to the first end wall 213. The bottom wall 211, the side walls 212, the first end wall 213, and the second end wall 214 may encircle to form a cavity. Further, in some embodiments, the holder 21 may further include a first isolating wall 215 and a second isolating wall 216. The first isolating wall 215 may be arranged on the bottom wall 211 and is close to the first end wall 213, and may be spaced apart from and parallel to the first end wall 213. The second isolating wall 216 is arranged on the bottom wall 211 and close to the second end wall 214, and may be spaced apart from and parallel to the second end wall 214. The first isolating wall 215 and the second isolating wall 216 may separate the cavity that may be formed by the encircling of the bottom wall 211, the side walls 212, the first end wall 213, and the second end wall 214 into three cavities. Further, in some embodiments, the holder 21 may include a first accommodating cavity 2101, a second accommodating cavity 2102, and a third accommodating cavity 2103. The first accommodating cavity 2101 may be configured to accommodate the battery cell 30, and may be located between the first isolating wall 215 and the second isolating wall 216. The second accommodating cavity 2102 may be configured to accommodate the first circuit board 40, and may be located between the first end wall 213 and the first isolating wall 215. The third accommodating cavity 2103 may be configured to accommodate the second circuit board 50, and may be located between the second end wall 214 and the second isolating wall 216.

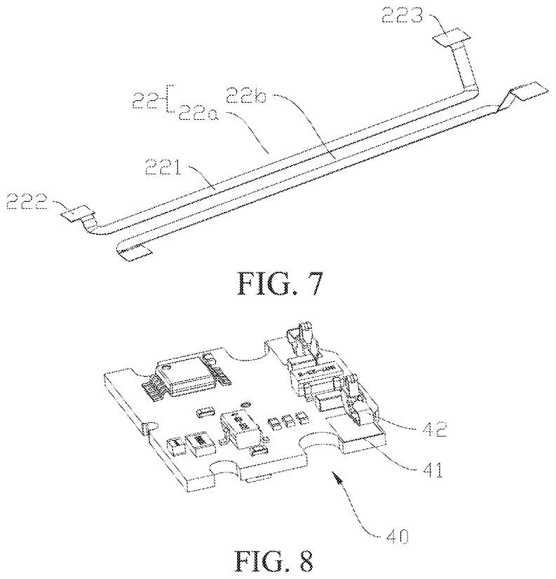

As shown in FIG. 5 to FIG. 7, further, in this embodiment, the conductive structure 22 may be formed on the holder 21 by using a laser direct structuring (LDS) process and forms an integral structure with the holder 21. Specifically, in this embodiment, the whole conductive structure 22 may be formed on the bottom wall 211, located on the inner surface of the bottom wall 211, and integrally formed with the bottom wall 211. Certainly, it may be understood that, in some other embodiments, the conductive structure 22 may be partially formed on the bottom wall 211, and may be integrally formed with the bottom wall 211. In some other embodiments, the conductive structure 22 may not be limited to being formed on the inner surface of the bottom wall 211. In this embodiment, the conductive structure 22 may be formed in the first accommodating cavity 2101. One end of the conductive structure 22 may extend from the first accommodating cavity 2101 to the second accommodating cavity 2102, and the other end may extend from the first accommodating cavity 2101 to the third accommodating cavity 2103. The two ends are electrically connected to the first circuit board 40 and the second circuit board 50 respectively. Certainly, it may be understood that, in some other embodiments, the conductive structure 22 may not be limited to being arranged in the first accommodating cavity 2101 and extending from the first accommodating cavity 2101 to the second accommodating cavity 2102 and from the first accommodating cavity 2101 to the second accommodating cavity 2103.

Further, in this embodiment, the conductive structure 22 may include two conductive members 22a, 22b. The two conductive members 22a, 22b may include a first conductive member 22a and a second conductive member 22b. The first conductive member 22a may be a positive electrode conductive member and connected to positive terminals of the first circuit board 40 and the second circuit board 50. The second conductive member 22b may be a negative electrode conductive member and connected to negative terminals of the first circuit board 40 and the second circuit board 50. It may be understood that, in some other embodiments, the conductive members 22a, 22b may not be limited to two, and may be one or more than two. In this embodiment, structures of the first conductive member 22a and the second conductive member 22b are substantially the same. In this embodiment, the two conductive members 22a, 22b both may be formed on the bottom wall 211 of the holder 21 by using the LDS process.

Further, in this embodiment, the conductive members 22a, 22b each may include a conductive connection portion 221, a first electrode 222, and a second electrode 223. The conductive connection portion 221, the first electrode 222, and the second electrode 223 may be integrally formed, may be formed on the holder 21 by using the LDS process, and may form an integral structure with the holder 21. In this embodiment, the first electrodes 222 on the two conductive members 22a, 22b may be arranged in mirror symmetry, and the second electrodes 223 on the two conductive members 22a, 22b may be arranged in mirror symmetry. Certainly, it may be understood that, in some other embodiments, the first electrodes 222 of the two conductive members 22a, 22b may not be limited to being arranged in mirror symmetry, and the second electrodes 223 on the two conductive members 22a, 22b may not be limited to being arranged in mirror symmetry.

The conductive connection portion 221 may be in an elongated sheet-shaped structure, and the whole conductive connection portion may be formed on the holder 21 by using the LDS process. Specifically, the conductive connection portion 221 may be formed on the inner surface of the bottom wall 211 by using the LDS process, and may be located in the first accommodating cavity 2101. The two ends of the conductive connection portion respectively extend toward the second accommodating cavity 2102 and the third accommodating cavity 2103. Certainly, it may be understood that, in some other embodiments, the conductive connection portion is not limited to that the whole conductive connection portion is formed on the holder 21 by using the LDS process.

The first electrode 222 may be arranged on one end of the conductive connection portion 221, and may be connected to the conductive connection portion 221. Specifically, in this embodiment, the first electrode 222 may extend toward the second accommodating cavity 2102, and may be formed in the second accommodating cavity 2102 by using the LDS process and configured to be electrically connected to the first circuit board 40. Specifically, in this embodiment, a first positioning boss 2111 is arranged on the bottom wall 211 and may protrude toward the second accommodating cavity 2102. The first positioning boss 2111 is located in the second accommodating cavity 2102 and may be integrally formed with the bottom wall 211. The first electrode 222 may be formed on the first positioning boss 2111 by using the LDS process, to conveniently abut against the first circuit board 40.

The second electrode 223 may be arranged on the other end of the conductive connection portion 221 and connected to the conductive connection portion 221. Specifically, in this embodiment, the second electrode 223 may extend toward the third accommodating cavity 2103, and may be formed in the third accommodating cavity 2103 by using the LDS process and configured to be electrically connected to the second circuit board 50. Specifically, in this embodiment, a second positioning boss 2112 is arranged on the bottom wall 211 and may protrude toward the third accommodating cavity 2103. The second positioning boss 2112 may be located in the third accommodating cavity 2103 and may be integrally formed with the bottom wall 211. The second electrode 223 may be formed on the second positioning boss 2112 by using the LDS process, to be electrically connected to the second circuit board 50 conveniently.

Further, in this embodiment, the battery cell 30 may be accommodated in the first accommodating cavity 2101. The battery cell 30 may be a rechargeable battery, and may supply power through an external power supply, thereby continuously supplying electric energy to the vaporizer, improving cycle performance of the power supply assembly, and reducing resource waste. In this embodiment, the battery cell 30 may include a battery cell body 31 and electrode plates 32. The battery cell body 31 may be accommodated in the first accommodating cavity 2101. The electrode plates 32 may be arranged on one end of the battery cell body 31, extend toward the second accommodating cavity 2102, and be connected to the first circuit board 40. There may be two electrode plates 32 which may be a positive electrode plate and a negative electrode plate and welded on the first circuit board 40. The battery cell 30 may include a first end 3101 and a second end 3102. The first end 3101 and the second end 3102 may extend in the length direction of the battery cell 30. The conductive structure may extend from the first end 3101 of the battery cell 30 to the second end 3102 of the battery cell 30, and at least two first electrodes 222 of the conductive structure 22 are located on the first end 3101 of the battery cell 30. Specifically, the first electrodes 222 may extend from the bottom wall 211 along the first end 3101 of the battery cell 30. At least two second electrodes 223 of the conductive structure 22 are located on the second end of the battery cell 30. Specifically, the second electrodes 223 may extend from the bottom wall 211 along the second end 3102 of the battery cell 30.

As shown in FIG. 8, further, in this embodiment, the first circuit board 40 may be accommodated in the second accommodating cavity 2102, and may include a first board body 41 and first elastic electrodes 42 arranged on the first board body 41. The first elastic electrodes 42 and the first electrodes 222 may be arranged in a one-to-one correspondence, and therefore the first elastic electrodes 42 may elastically abut against the first electrodes 222. In some embodiments, the first elastic electrodes 42 may be in an elastic piece structure and may be arranged on the first board body 41 by using a surface-mount technology (SMT), thereby implementing an electrical connection between the conductive structure 22 and the first circuit board 40. In this embodiment, an airflow sensing apparatus 43 may be arranged on the first board body 41 and may be located on the side of the first board body 41 opposite to the first elastic electrodes 42. The airflow sensing apparatus 43 may be electrically connected to the first circuit board 40 and may be configured to start the vaporizer A. In some embodiments, the airflow sensing apparatus 43 may be a microphone or a MEMS sensor.

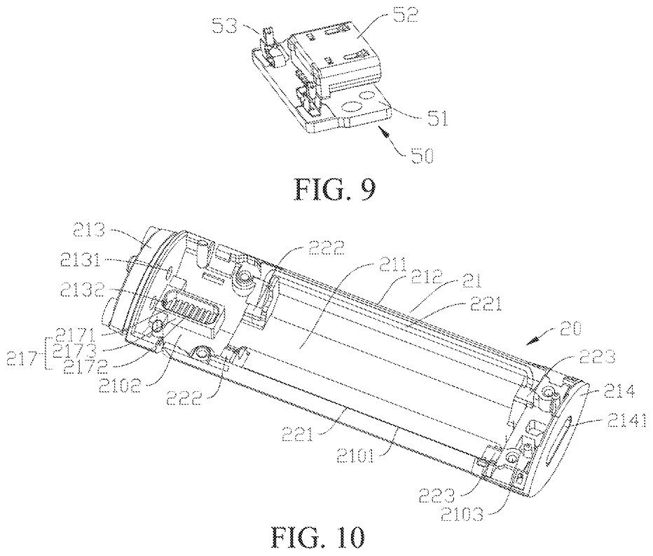

As shown in FIG. 9, further, in this embodiment, the second circuit board 50 may be accommodated in the second accommodating cavity 2102 and may include a second board body 51, a charging interface 52 arranged on the second board body 51, and second elastic electrodes 53 arranged on the second board body 51. The second board body 51 may be electrically connected to the charging interface 52. The charging interface 52 may be accommodated in the second accommodating cavity 2102, and a plug interface 2141 arranged corresponding to the charging interface 52 may be arranged on the second end wall 214. In some embodiments, the charging interface 52 may be a USB interface and may be connected to an external power supply, to access electrical energy to the second circuit board 50, thereby charging the battery cell 30. It may be understood that, in some other embodiments, the charging interface 52 may not be limited to the USB interface. In this embodiment, the second elastic electrodes 53 may be arranged on the second board body 51. The second elastic electrodes 53 and the second electrodes 223 may be arranged in a one-to-one correspondence, and therefore the second elastic electrodes 53 may elastically abut against the second electrodes 223. In some embodiments, the second electrodes 223 may be in an elastic piece structure, may be arranged on the second board body 51 by using the SMT, and implements an electrical connection between the second circuit board 50 and the conductive structure 22 by elastically abutting against the second electrodes 223.

Further, in this embodiment, the power supply assembly may further include an air guide component 60. The air guide component 60 may be configured to guide air for the airflow sensing apparatus 43, thereby facilitating starting of the airflow sensing apparatus 43. Further, in this embodiment, the air guide component 60 may be located in the second accommodating cavity 2102, and in some embodiments, the air guide component 60 may be a silicone member. Certainly, it may be understood that, in some other embodiments, the air guide component 60 may not be limited to the silicone member, and may be made of another soft material. The air guide component 60 may be arranged on the side of the first circuit board 40 opposite to the airflow sensing apparatus 43 and may be connected to the airflow sensing apparatus 43.

Further, in this embodiment, an anti-leakage structure 217 may be further arranged on the holder 21. The anti-leakage structure 217 may be integrally formed with the holder 21, and may be configured to prevent a liquid medium in an airflow channel from leaking. The anti-leakage structure 217 may be located in the second accommodating cavity 2102 of the holder 21, and may be located on the bottom wall 211 and integrally formed with the bottom wall 211 by injection molding. Specifically, in some embodiments, the anti-leakage structure 217 may be integrally formed with the bottom wall 211 by injection molding. In this embodiment, the anti-leakage structure 217 may be arranged facing the air guide component 60, and may form a main channel of the airflow channel with the air guide component 60.

In this embodiment, the anti-leakage structure 217 may include a liquid absorbing groove 2171. The liquid absorbing groove 2171 may be arranged on the holder 21, located in the second accommodating cavity 2102, and located on the bottom wall 211. The liquid absorbing groove 2171 may be a capillary groove, and may absorb, by generating a capillary force, a liquid medium flowing from the airflow channel, thereby reducing corrosion of the liquid medium on the airflow sensing apparatus 42 and the first circuit board 40. In some embodiments, there may be a plurality of liquid absorbing grooves 2171, and the plurality of liquid absorbing grooves 2171 are arranged side by side in a direction away from vent holes 2131, thereby gradually storing the liquid medium. Specifically, the liquid absorbing grooves 2171 may be arranged side by side in the air flow direction in the airflow channel 100. In this embodiment, the vent holes 2131 are provided on the first end wall 213, and the liquid absorbing grooves 2171 may be strip-shaped grooves and arranged extending along the two sides of the vent holes 2131 in a direction perpendicular to the air inlet direction of the vent holes 2131, that is, horizontal opening grooves, thereby reducing time of downward flow of a condensate.

Further, in this embodiment, the anti-leakage structure 217 may further include a groove wall 2172. The groove wall 2172 may be substantially in a cuboid structure, may be a frame, and may be arranged on the periphery of the liquid absorbing grooves 2171, so that the plurality of liquid absorbing grooves 2171 are provided in the groove wall 2172. The groove wall 2172 may encircle to form an embedded groove 2173, and the embedded groove 2173 may be configured for embedding and mounting of the air guide component 60.

Further, in this embodiment, the power supply assembly B may further include a seal member 70. The seal member 70 may cover an opening of the second accommodating cavity 2102, may be arranged on and press against the first circuit board 40, and may be fastened to the holder 21 by screws.

Further, in this embodiment, the power supply assembly B may further include a seal sleeve 80. The seal sleeve 80 may be sleeved on the first end wall 213 and may be connected to the shell 10 in a sealed manner. In some embodiments, the seal sleeve 80 may be a silicone sleeve.

Further, in this embodiment, the power supply assembly B may further include ejector pins 90, and the two ejector pins 90 may be mounted on the first end wall 213. One end of each ejector pin 90 abuts against the vaporizer A, and the other end is electrically connected to the first circuit board 40. Through holes 2132 are provided on the first end wall 213 and are in a one-to-one correspondence with the ejector pins 90 for the ejector pins 90 to run through, and the through holes 2132 may be in communication with the second accommodating cavity 2102.

Further, in this embodiment, the power supply assembly B may further include a light post 100. The light post 100 may be arranged on the seal member 70, may pass through the shell 10, and may be connected to the first circuit board 40 and configured to display a use state of the vaporizer A.

FIG. 10 shows a second embodiment of the electronic vaporization device of the present invention. A difference from the first embodiment lies in that the conductive structure 22 may be partially formed on the side wall 212 by using the LDS process. Further, in this embodiment, the conductive structure 22 is formed on the inner surface of the side wall 212. Specifically, a conductive connection structure of the conductive structure 22 is formed on the inner surface of the side wall 212. The first electrodes 222 are formed on the inner surface of the bottom wall 211 by using the LDS process and are located on the first positioning boss 2111. The second electrodes 222 are formed on the inner surface of the bottom wall 211 by using the LDS process and are located on the second positioning boss 2111. The two conductive members 22a, 22b and the two side walls 212 may be arranged in a one-to-one correspondence.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A holder assembly, comprising:
a holder configured to accommodate a battery cell; and
a conductive structure arranged on the holder,
wherein the conductive structure is formed on the holder using a laser direct structuring (LDS) process and forms an integral structure with the holder.

2. The holder assembly of claim 1, wherein the holder comprises a bottom wall, and the conductive structure is at least partially formed on an inner surface of the bottom wall.

3. The holder assembly of claim 1, wherein, the holder comprises a side wall, and the conductive structure is at least partially formed on an inner surface of the side wall.

4. The holder assembly of claim 1, wherein the battery cell comprises a first end extending in a length direction and a second end arranged opposite the first end, and
wherein the conductive structure extends from the first end of the battery cell to the second end.

5. The holder assembly of claim 1, wherein the holder comprises a first accommodating cavity accommodating the battery cell, and
wherein the conductive structure is formed in the first accommodating cavity.

6. The holder assembly of claim 5, wherein the holder comprises a second accommodating cavity accommodating a first circuit board, and
wherein the conductive structure extends from the first accommodating cavity to the second accommodating cavity.

7. The holder assembly of claim 5, wherein the holder comprises a third accommodating cavity accommodating a second circuit board, and
wherein the conductive structure extends from the first accommodating cavity to the third accommodating cavity.

8. The holder assembly of claim 6, wherein the conductive structure comprises a first electrode extending toward the second accommodating cavity, and
wherein the first electrode is formed in the second accommodating cavity using the LDS process, to abut against a first elastic electrode arranged on the first circuit board.

9. The holder assembly of claim 8, wherein a first positioning boss is arranged in the second accommodating cavity, and
wherein the first electrode is formed on the first positioning boss.

10. The holder assembly of claim 7, wherein the conductive structure comprises a second electrode extending toward the third accommodating cavity, and
wherein the second electrode is formed in the third accommodating cavity using the LDS process, to abut against a second elastic electrode arranged on the second circuit board.

11. The holder assembly of claim 10, wherein a second positioning boss is arranged in the third accommodating cavity, and
wherein the second electrode is formed on the second positioning boss.

12. The holder assembly of claim 1, wherein the conductive structure comprises at least one conductive member comprising an elongated conductive connection portion, and the conductive connection portion is formed on the holder by the LDS process.

13. The holder assembly of claim 12, wherein a first electrode is arranged on an end of the conductive connection portion of each conductive member of the at least one conductive member, and a second electrode is arranged on an other end of the conductive connection portion of each conductive member of the at least one conductive member.

14. The holder assembly of claim 13, wherein the conductive connection portion, the first electrode, and the second electrode are integrally formed on the holder using the LDS process, and form an integral structure with the holder.

15. The holder assembly of claim 1, wherein the conductive structure comprises at least two conductive members,
wherein a first electrode is arranged on each conductive member of the at least two conductive members, and
wherein the first electrodes on two adjacently arranged conductive members of the at least two conductive members are arranged in mirror symmetry.

16. The holder assembly of claim 1, wherein the conductive structure comprises at least two conductive members,
wherein a second electrode is arranged on each conductive member of the at least two conductive members, and
wherein the second electrodes on two adjacently arranged conductive members of the at least two conductive members are arranged in mirror symmetry.

17. A power supply assembly, comprising:
the holder assembly of claim 1; and
a battery cell arranged on the holder assembly.

18. An electronic vaporization device, comprising:
the power supply assembly of claim 17; and
a vaporizer connected to the power supply assembly.
